(19) United States
(12) Patent Application Publication
(10) Pub. No.: US 2011/0272061 A1
(43) Pub. Date: Nov. 10, 2011

(54) THIN FILM SOLAR JUNCTION BOX POTTANT VACUUM FILL PROCESS

(75) Inventors: Eric Benson, San Francisco, CA (US); Danny Cam Toan Lu, San Francisco, CA (US); Jeffrey S. Sullivan, Castro Valley, CA (US)

(73) Assignee: APPLIED MATERIALS, INC., Santa Clara, CA (US)

(21) Appl. No.: 12/774,391

(22) Filed: May 5, 2010

(51) Int. Cl. B65B 31/00; B29C 70/72

(52) U.S. Cl. 141/59; 156/285

(57) ABSTRACT

A method for vacuum filling a junction box and a junction box attachment module are provided. According to one embodiment of the invention, a junction box attachment module includes a dispense nozzle, an enclosure and a vacuum source. The enclosure is disposed around and extended from the dispense nozzle, wherein the enclosure has a sealing portion located at its open end. The vacuum source is connected to the enclosure, wherein the vacuum source is configured to establish a vacuum within the enclosure enclosing an open region of a junction box attached to a solar cell device, thereby facilitating injecting a potting material into the open region of the junction box via the dispense nozzle.

### BACKGROUND OF THE INVENTION

1. Field of the Invention

Embodiments disclosed herein generally relate to a junction box attachment module and a method that are useful for creating an effective pottant (potting material) fill environment for attaching a junction box to a solar cell device.

2. Description of Related Art

A photovoltaic (PV) device or solar cell is a device that converts sunlight energy directly into electricity. The PV device or solar cell includes a junction box, a device substrate and a back glass substrate bonded to the device substrate, wherein the device substrate is a substrate having one or more deposited layers and one or more internal electrical connections such as side buss and cross-buss disposed thereon. The junction box acts as an interface between the external electrical components that will connect to the device substrate, such as other solar cells or a power grid, and the internal electrical connections of the device substrate. Since the solar cell is usually exposed to effects of weather such as rain, snow, wind etc., it is particularly important that the junction box has weatherproof properties including the resistance against moisture, water or temperature differences. Therefore, after the junction box is attached to the back glass substrate, a potting material is required to fill in an open region of the junction box, thereby providing protection to withstand the environmental attacks and electrical insulation of components.

The junction box has to be designed and processed to meet all IEC (International Electrotechnical Commission) and UL (Underwriters Laboratories) specifications and testing. If the open region of the junction box is not properly filled with the potting material resulting in minimal or no voids therein, there is a higher risk of failing environmental testing and reducing the reliability and performance of the solar cell, thus failing to meet IEC and UL standards.

In a conventional pottant-fill process, the potting material is filled in the open region of the junction box by use of a dispense nozzle disposed on a head assembly of a junction box attachment module. However, due to a relative high viscosity of the potting material, the conventional skill has difficulty in injecting the potting material smoothly into the open region of the junction box, thus likely creating voids therein.

Therefore, it is desirable to provide a junction box attachment module and a method for filling the potting material in a junction box with minimal or no voids formed therein.

### SUMMARY OF THE INVENTION

According to one aspect of the invention, a junction box attachment module includes a dispense nozzle, an enclosure and a vacuum source. The enclosure is disposed around and extended from the dispense nozzle, wherein the enclosure has a sealing portion located at its open end. The vacuum source is connected to the enclosure, wherein the vacuum source is configured to establish a vacuum within the enclosure enclosing an open region of a junction box attached to a solar cell device, thereby facilitating injecting a potting material into the open region of the junction box via the dispense nozzle.

In another aspect, the junction box attachment module includes a gantry system and a head assembly. The head assembly is mounted on the gantry system, wherein the head assembly includes the dispense nozzle.

In another aspect, the junction box attachment module includes a vision system, a robotic gripper and a heating assembly. The vision system is configured to scan the solar cell device and locate an electrical lead on the solar cell device. The robotic gripper has gripping elements configured to pick up, manipulate and place the junction box onto the solar cell device such that an electrical connection tab within the junction box is in contact with the electrical lead using information from the vision system. The heating assembly includes a heating element, wherein the heating element is configured to contact the electrical connection tab so as to form a bond between the electrical connection tab and the electrical lead which are disposed in the open region of the junction box.

In another aspect, a method for attaching a junction box to a solar cell device is provided. The method includes applying an adhesive sealant to a sealing surface of a junction box; picking up the junction box via a robotic gripper; positioning the junction box onto the solar cell device such that electrical connection tabs within the junction box are in contact with electrical leads on the solar cell device and the junction box is attached to the solar cell device via the adhesive sealant; positioning heating elements in contact with the electrical connection tabs or the electrical leads, thereby forming bonds between the electrical connection tabs and the electrical leads which are disposed in an open region of the junction box; positioning a dispense nozzle with an enclosure in communication with the open region of the junction box; controlling a first pressure within the enclosure enclosing the open region of the junction box once a sealing portion of the enclosure is in contact with the junction box, such that the first pressure is lower than a second pressure outside the enclosure; and dispensing a potting material to fill the open region of the junction box via the dispense nozzle when the first pressure is lower than the second pressure.

In another aspect, the method includes establishing a vacuum within the enclosure relative to the second pressure outside the enclosure.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a schematic side cross-sectional view of a device substrate in accordance with one embodiment.

FIG. 1B is a schematic plan view of a composite solar cell structure in accordance with one embodiment.

FIG. 1C is a schematic plan view of a thin film solar cell in accordance with one embodiment.

FIG. 2A is a schematic isometric view showing a junction box attachment module in accordance with one embodiment.

FIG. 2B is a schematic front view of one embodiment of the assembly head depicted in FIG. 2A.

FIG. 2C is a schematic front view of another embodiment of the assembly head depicted in FIG. 2A.

FIG. 3 illustrates a processing sequence for attaching the junction box to the composite solar cell structure in accordance with one embodiment.

FIG. 4 illustrates a processing sequence for performing a pottant-fill step in accordance with one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments disclosed herein are generally directed to using a junction box attachment module having a dispense nozzle with an enclosure in communication with an open region of a junction box to establish a vacuum within the enclosure enclosing the open region of the junction box, such that a potting material can be smoothly injected into the open region of the junction box from the dispense nozzle with minimal or no voids formed therein.

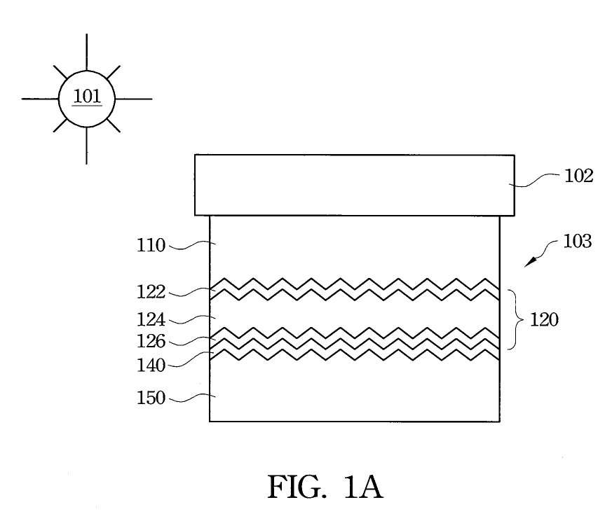

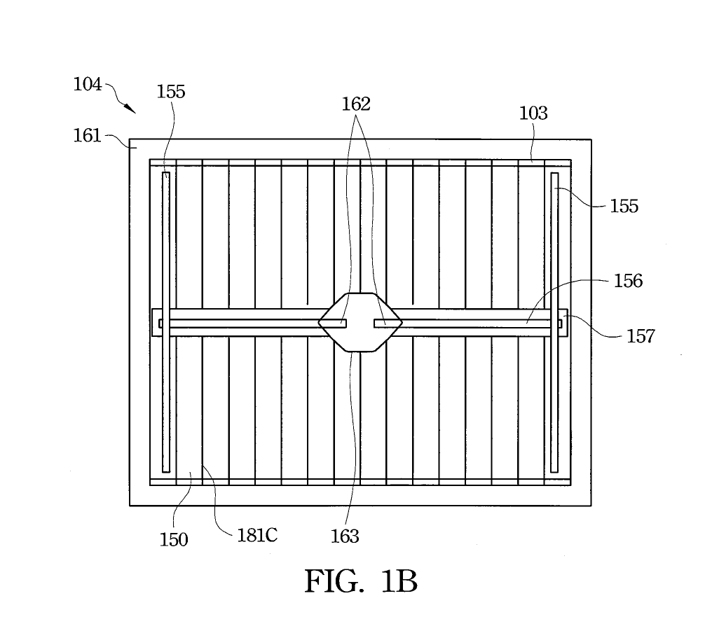

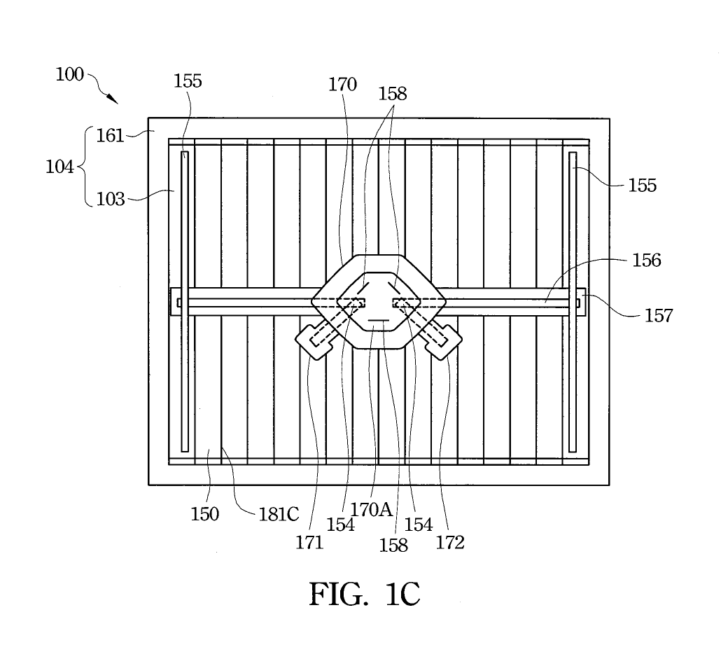

Examples of a solar cell that can be processed using a junction box attachment according to the embodiments of the present invention are illustrated in FIG. 1A to FIG. 1C.

Referring to FIG. 1A to FIG. 1C, FIG. 1A is a schematic side cross-sectional view of a device substrate 103 in accordance with one embodiment; FIG. 1B is a schematic plan view showing the rear surface of a composite solar cell structure 104 in accordance with one embodiment, and FIG. 1C is a schematic plan view showing the rear surface of a solar cell 100 in accordance with one embodiment, wherein the composite solar cell structure 104 is the solar cell 100 prior to the attachment of a junction box 170, and the device substrate 103 is the composite solar cell structure 104 prior to the bonding of a back glass substrate 161.

As shown in FIG. 1A, the device substrate 103 (solar cell) is oriented toward to solar radiation 101, and includes a substrate 102, a first transparent conducting oxide (TCO) layer 110 formed over the substrate, at least one p-i-n junction 120 formed over the first TCO layer 110, a second TCO layer 140 formed over the p-I-n junction layer 120, and a back contact layer 150 formed over the second TCO layer 140. In one configuration, the p-i-n junction 120 may include a p-type amorphous silicon layer 122, an intrinsic type amorphous silicon layer 124 formed over the p-type amorphous silicon layer 122, an n-type amorphous silicon layer 126 formed over the intrinsic type amorphous silicon layer 124.

As shown in FIG. 1B, the composite solar cell structure 104 includes the device substrate 103, the back glass substrate 161, and a layer of bonding material (not shown) for bonding the device substrate 103 to the back glass substrate 161. One or more internal electrical connections such as side-buss 155 and cross-buss 156 are formed on the back contact layer 150 of the device substrate 103. The cross-buss 156, which is electrically connected to the side-buss 155 at the junctions, can be electrically isolated form the back contact layer 150 by use of an insulating material 157. The end of each cross-buss 156 generally has an electrical lead 162 used to connect the side-buss 155 and the cross-buss 156 to the electrical connections found in the junction box 170 (as shown in FIG. 1C). The back glass substrate 161 may include an opening 163 for exposing the leads 162 of the cross-buss 156. An insulating trench 181C is formed on the back contact layer 150 and the p-i-n junction 120 (FIG. 1A) to isolate individual cells (not shown) formed together on the substrate 102 (FIG. 1A).

As shown in FIG. 1C, the junction box 170 includes two junction box terminals 171 and 172 with electrical connection tabs 154 that are electrically connected to the solar cell 100 (composite solar cell structure 104) through the side-buss 155 and the cross-buss 156 via the leads 162, all of which are in electrical communication with the back contact layer 150 and active regions of the solar cell 100. The junction box 170 acts as an interface between the solar cell 100 and the external electrical components such as other solar cells or a power grid. In one embodiment, the two junction box terminals 171 and 172 can allow the solar cell 100 to be easily and systematically connected to other external devices to deliver the generated electrical power.

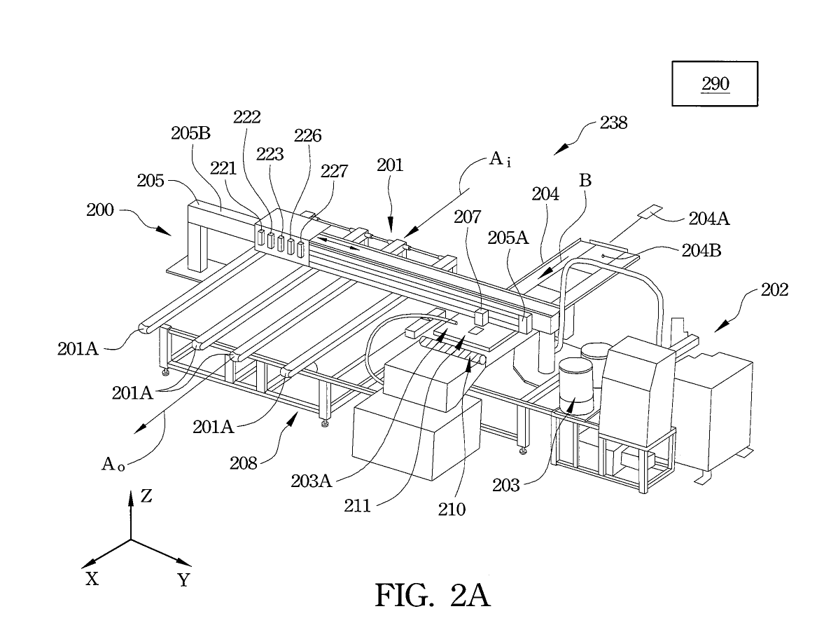

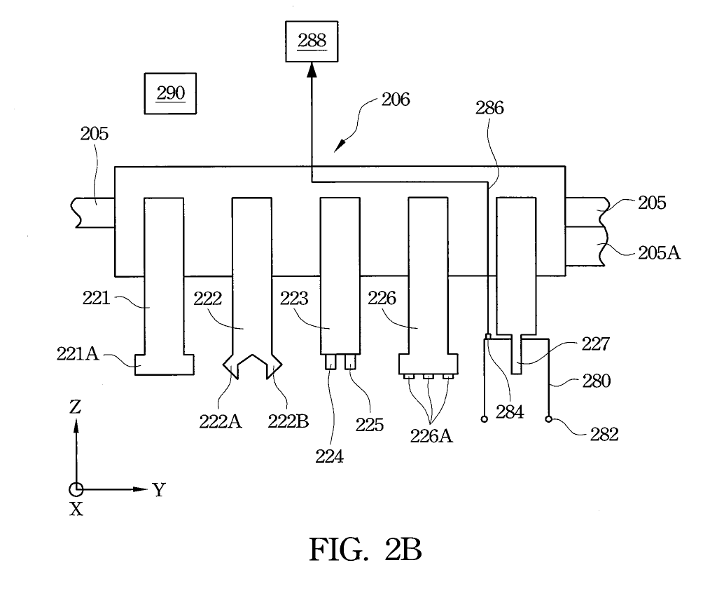

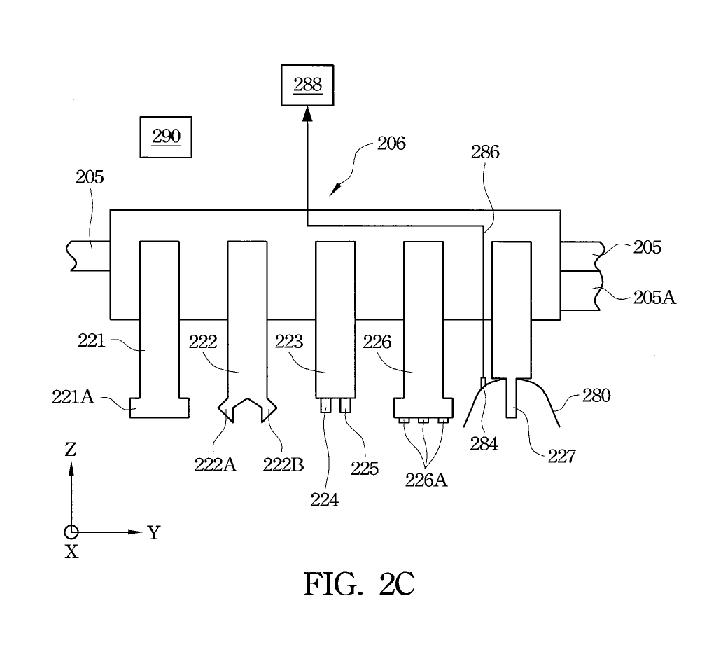

Embodiments of a junction box attachment module used for attaching the junction box 170 to the solar cell 100 (composite solar cell structure 104) are illustrated in FIG. 2A to FIG. 2C.

Referring to FIG. 2A, FIG. 2A is a schematic isometric view showing a junction box attachment module 238 in accordance with one embodiment. The junction box attachment module 238 includes a main structure 200, an adhesive dispense assembly 202, a potting material dispense assembly 203, a junction box conveyor assembly 204, a gantry system 205, a head assembly 206, a flux dispense assembly 212, and a conveyor system 201, all monitored and controlled by a system controller 290.

In one embodiment, the main structure 200 includes a support structure 208 adapted to support and retain various systems of the junction box attachment module 238, and the conveyor system 201 includes conveyor belts 201A mounted on the support structure 208 to allow the composite solar cell structure 104 (FIG. 1B) to be positioned and transferred through the junction box attachment module 238 following path Aᵢ to path Aₒ. The gantry system 205 supported by the support structure 208 includes structure components 205B and an actuator 205A that are used to move the head assembly 206 over the composite solar cell structure 104 positioned on the conveyor system 201.

In one embodiment, the junction box conveyor assembly 204 is configured to receive junction box components, such as the junction box 170 and a junction box lid 170A (FIG. 1C), from an automated supply device 204A, and deliver them to a receiving region 211 of the junction box attachment module 238. The head assembly 206 is used to receive and place the junction box 170 and the junction box lid 170A onto the composite solar cell structure 104 positioned on the conveyor system 201. In one embodiment, the junction box conveyor assembly 204 is to receive and move a tray 210 of junction box components to the receiving region 211 along path B using a conveyor 204B.

In one embodiment, the gantry system 205 includes a robotic arm assembly 207. The robotic arm assembly 207 is configured to pickup the junction box 170 from the tray 210, and to move the junction box 170 into a position for dispensing adhesive and flux. The adhesive dispense assembly 202 includes components adapted to deliver an adhesive to a nozzle in a dispense head assembly 203A for disposing the adhesive upon a sealing surface of the junction box 170. The flux dispense assembly 212 includes components adapted to deliver a flux material to a nozzle in the dispense head assembly 203A for dispensing the flux material onto the electrical connection tabs 154 (FIG. 1C) in the junction box 170 and/or the leads 162 of the cross-buss 156 (FIG. 1B) to improve the wetting of the solder material therebetween.

In one embodiment, the potting material dispense assembly 203 includes components adapted to deliver a potting material, such as a two part room temperature vulcanizing (RTV) material, to an open region 165 (FIG. 1C) of the junction box 170 using a dispense nozzle 227 disposed on the head assembly 206. The open region 165 of the junction box 170 is formed after the junction box has been attached to the composite solar cell structure 104 using the adhesive delivered via the dispense head assembly 203A from the adhesive dispense assembly 202. In one embodiment, a desired amount of each of the two parts of potting material are simultaneously delivered to the open region 165 of the junction box 170 by use of the system controller 290.

Referring to FIG. 2B, FIG. 2B is an enlarged, schematic, front view of one embodiment of the head assembly 206 shown in FIG. 2A. In one embodiment, the head assembly 206 mounted on the gantry system 205 includes a dispense nozzle 227, an enclosure 280 disposed around the dispense nozzle 227, a vision system 221, a robotic gripper 222, a heating assembly 223 and a lid retrieving robot 226. The enclosure 280 has a sealing portion 282 located at the open end of the enclosure 280, wherein the sealing portion 282 can be formed from an elastomeric material or any other material suitable for providing a low pressure differential seal. The enclosure 280 is connected to a vacuum source 288 via a port 284 and a vacuum line 286 running through the gantry system 206. In one embodiment, once the sealing portion 282 of the enclosure 280 is in contact with the junction box 170 or area of the back glass substrate 161 surrounding the junction box 170, the vacuum source 288 is configured by the system controller 290 to establish a lower pressure (such as vacuum) within the enclosure 280 enclosing the open region 165 of the junction box 170 attached to the solar cell 100 (composite solar cell structure 104). The lower pressure or vacuum within the enclosure 280 enclosing the open region 165 of the junction box 170 establishes an environment which substantially prevents voids and/or bubbles from forming in the dispensed pottant. Thus, the open region 165 of the junction box 170 can be filled densely with the potting material, with minimal or no voids present in the potting material filled in the region 165 (which is not exposed until after being filled with the potting material) of the junction box 170.

Referring to FIG. 2C, FIG. 2C is an enlarged, schematic, front view of another embodiment of the head assembly 206 shown in FIG. 2A. In one embodiment, the enclosure 280 is a dome-like structure formed from an elastomeric material. The elastomeric enclosure 280 conforms to the junction box 170 or area of the back glass substrate 161 around the junction box 170 so that a low pressure environment may be established in the opening 165.

In one embodiment, the vision system 221 including a camera 221A is configured to scan the solar cell device 100 and locate the electrical lead 162 on the solar cell device 100. In one embodiment, the vision system 221 including the camera 221A and the system controller 290 are adapted to scan the composite solar cell structure 104 and locate the electrical lead 162 and the opening 163 as the gantry system 205 moves the head assembly 206 (y-direction motion) and as the conveyor system 201 moves the composite solar cell structure 104 (x-direction).

In one embodiment, the robotic gripper 222 includes gripping elements 222A and 222B adapted to mate with datum surfaces 158 (FIG. 2C) located on the junction box 170, and the gripping elements 222A and 222B can be configured to pick up, manipulate and place the junction box 170 onto the solar cell device 100 using information from the vision system 221, thereby accurately placing the electrical connection tab 154 within the junction box 170 to be in contact with the electrical lead 162.

In one embodiment, the heating assembly 223 includes heating elements 224 and 225, such as resistive heating elements. The heating elements 224 can be configured to simultaneously contact the two electrical connection tabs 154 and the two electrical leads 161 by heating and causing reflow of the solder located therebetween, thereby forming bonds between the electrical connection tabs 154 and the electrical leads 161 which are disposed in the open region 165 of the junction box 170.

In one embodiment, the lid retrieving robot 226 is adapted to receive the junction box lid 170A from the receiving region 211 and position it over the junction box 170 after the region 165 of the junction box 170 is filled with the potting material. The lid retrieving robot 226 may include one or more vacuum end-effectors 226A that are adapted to receive and hold the junction box lid 170A as the lid retrieving robot 226 is operated.

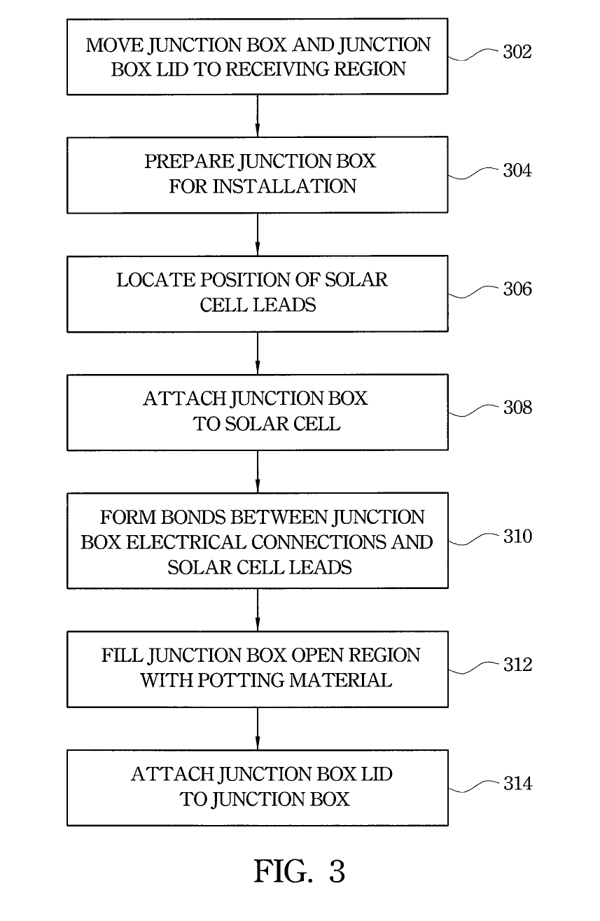

Referring to FIGS. 1, 2A-2C and 3, FIG. 3 illustrates a processing sequence 300 for attaching the junction box 170 to the composite solar cell structure 104 in accordance with one embodiment. The configuration, number of processing steps, and order of the processing steps shown in FIG. 3 are not intended to be limiting to the scope of the invention described herein.

In one embodiment, the processing sequence 300 generally begins at step 302 in which one or more junction boxes 170 and/or one or more junction box lids 170A are moved to the receiving region 211 of the junction box attachment module 238 using the junction box conveyor assembly 204.

In step 304, the junction box 170 is prepared for installation on the solar cell 100 (composite solar cell structure 104). During step 304, an adhesive sealant is applied to a sealing surface of the junction box 170. In one embodiment, the robotic arm assembly 207 receives the junction box 170 from the tray 210 and moves the junction box 170 to the dispense head assembly 203A, and the dispense head assembly 203A dispenses the adhesive sealant via a nozzle on the sealing surface of the junction box 170. In one embodiment, a flux material is also applied to the electrical connection tabs 154 via another nozzle in the dispense head assembly 203A.

In step 306, the vision system 221 in conjunction with the gantry system 205, head assembly 206, conveyor system 201 and system controller 290 scans the composite solar cell structure 104 to locate the positions of the electrical leads 162 and the openings 163 formed in the back glass substrate 161.

In step 308, the junction box 170 is picked up by the robotic gripper 222 and moved in a second direction (y-direction) via the head assembly 206 and the actuator 205A, and thereby the junction box 170 is positioned onto the solar cell device 100 (composite solar cell structure 104) which is moved in a first direction (x-direction) via the conveyor system 201, so that the adhesive sealant on the sealing surface of the junction box 170 can form a seal around the opening 163 contained in the back glass substrate 161. In one embodiment, the gripping elements 222A and 222B receive the datum surfaces 158 to correctly make the electrical connection tabs 154 within the junction box 170 in contact with the electrical leads 162 on the composite solar cell structure 104. In one embodiment, the gripping elements 222A and 222B press the junction box 170 and the adhesive sealant against the surface the back glass substrate 161 during installation, thereby obtaining an even spread of the adhesive sealant and good contact between the electrical leads 162 and the electrical connection tabs 154.

In step 310, the heating elements 224 and 225 of the heating assembly 223 are positioned in contact with the electrical connection tabs 154 or the electrical leads 162, and apply heat to the electrical connection tabs 154 sufficient to cause the solder material and flux located between the electrical connection tabs 154 and the electrical leads 162 to reflow and form bonds between the junction box 170 and the composite solar cell structure 104. In one embodiment, step 310 of positioning the heating elements 224 and 225 is performed using information provided by the vision system 221.

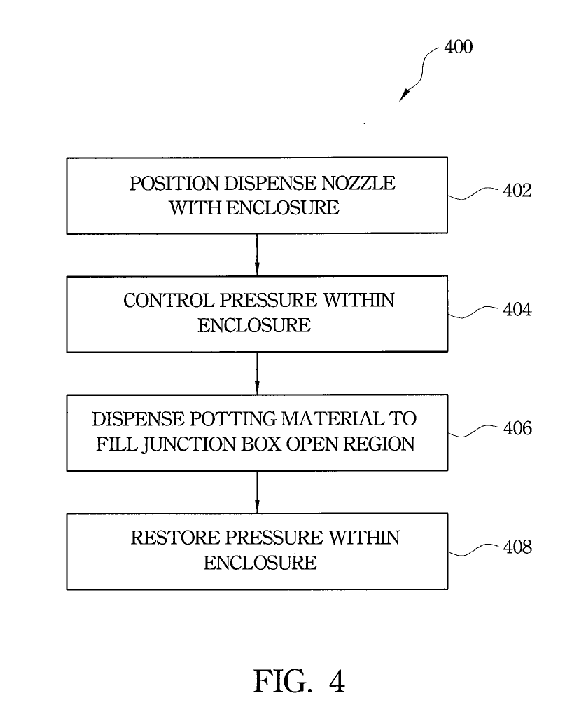

Thereafter, a pottant-fill step 312 is performed to fill the open region 165 of the junction box 170 with the potting material. Referring to FIG. 4, FIG. 4 is illustrates a processing sequence 400 for performing the pottant-fill operation of step 312. In step 402, the dispense nozzle 227 with the enclosure 280 is positioned in communication with the open region 165 of the junction box 170, wherein the sealing portion 282 of the enclosure 280 is positioned to contact the area around the open region 165 of the junction box 170. In one embodiment, the step of positioning the dispense nozzle 227 is performed using information provided by the vision system 221.

In step 404, once a sealing portion 282 of the enclosure 280 is in contact with the junction box 170 or back glass substrate 161, the pressure within the enclosure 280 enclosing the open region 165 of the junction box 170 is controlled to be lower than the pressure outside the enclosure 280. In one embodiment, the vacuum source 288 is activated to withdraw air within the enclosure 280, thereby establishing a vacuum within the enclosure 280 relative to the pressure outside the enclosure 280.

In step 406, when the pressure within the enclosure 280 is lower than the pressure outside the enclosure 280, the potting material is dispensed to fill the open region 165 of the junction box 170 via the dispense nozzle 227. The potting material, such as a polymeric material, is generally used to isolate active regions of the solar cell 100 and the electrical connections from environmental attack. Since embodiments of the present invention can create a low pressure condition (for example, vacuum in the enclosure 280), pottant can fill the open region 165 of the junction box 170 densely so that minimal or no voids are formed within the potting material filled in the region 165 (which is not open until after being filled with the potting material) of the junction box 170.

In step 408, after the region 165 of the junction box 170 is filled with the potting material, the pressure within the enclosure 280 is restored back to the pressure outside the enclosure 280, and then the enclosure 280 is removed from the junction box 170.

Referring back to FIGS. 2C and 3, in step 314, the junction box lid 170A is placed on and attached to the junction box 170 so that the region 165 of the junction box 170 can be further isolated from the external environment. In one embodiment, the lid retrieving robot 226 is configured to rotationally align the junction box lid 170A with respect to the composited solar cell structure 104 to properly angularly orient the junction box lid 170A with respect to the placement of the junction box 170.

While the foregoing is directed to embodiments of the present invention, other and further embodiments of the invention may be devised without departing from the basic scope thereof, and the scope thereof is determined by the claims that follow.

What is claimed is:

1. A junction box attachment module, comprising:
a dispense nozzle;
an enclosure disposed around and extended from the dispense nozzle, wherein the enclosure has a sealing portion located at its open end; and
a vacuum source connected to the enclosure, wherein the vacuum source is configured to establish a vacuum within the enclosure enclosing an open region of a junction box attached to a solar cell device, thereby facilitating injecting a potting material into the open region of the junction box via the dispense nozzle.

2. The module of claim 1, wherein the enclosure is formed from an elastomeric material.

3. The module of claim 1, wherein the sealing portion of the enclosure is formed from an elastomeric material.

4. The module of claim 1, wherein the enclosure is a dome-like structure.

5. The module of claim 1, further comprising:
a gantry system;
a head assembly mounted on the gantry system, wherein the head assembly comprises the dispense nozzle.

6. The module of claim 5, wherein the vacuum source is connected to the enclosure via a vacuum line running through the gantry system.

7. The module of claim 5, wherein the head assembly further comprises:
a vision system configured to scan the solar cell device and locate an electrical lead on the solar cell device;
a robotic gripper having gripping elements configured to pick up, manipulate and place the junction box onto the solar cell device such that an electrical connection tab within the junction box is in contact with the electrical lead using information from the vision system; and
a heating assembly comprising a heating element, wherein the heating element is configured to contact the electrical connection tab so as to form a bond between the electrical connection tab and the electrical lead which are disposed in the open region of the junction box.

8. A method for attaching a junction box to a solar cell device, comprising:
applying an adhesive sealant to a sealing surface of a junction box;
picking up the junction box via a robotic gripper;
positioning the junction box onto the solar cell device such that electrical connection tabs within the junction box are in contact with electrical leads on the solar cell device and the junction box is attached to the solar cell device via the adhesive sealant;
positioning heating elements in contact with the electrical connection tabs or the electrical leads, thereby forming bonds between the electrical connection tabs and the electrical leads which are disposed in an open region of the junction box;
positioning a dispense nozzle with an enclosure in communication with the open region of the junction box;
controlling a first pressure within the enclosure enclosing the open region of the junction box once a sealing portion of the enclosure is in contact with the junction box, such that the first pressure is lower than a second pressure outside the enclosure; and
dispensing a potting material to fill the open region of the junction box via the dispense nozzle when the first pressure is lower than the second pressure.

9. The method of claim 8, wherein the step of controlling the first pressure within the enclosure further comprises establishing a vacuum within the enclosure relative to the second pressure outside the enclosure.

10. The method of claim 8, wherein the step of controlling the first pressure within the enclosure comprises:
activating a vacuum source to control the first pressure within the enclosure.

11. The method of claim 8, further comprising:
scanning a solar cell device with a vision system to locate the electrical leads disposed on the solar cell device;

12. The method of claim 8, wherein the step of positioning the heating elements is performed using information provided by a vision system.

13. The method of claim 8, wherein the step of positioning the dispense nozzle is performed using information provided by a vision system.

14. The method of claim 8, further comprising:
moving the solar cell device in a first direction via a conveyor system; and
moving the junction box in a second direction via a head assembly and an actuator.

15. The method of claim 14, further comprising:
providing the dispense nozzle disposed on the head assembly.

16. The method of claim 8, further comprising:
restoring a pressure within the enclosure to the second pressure outside the enclosure;
removing the enclosure from the junction box; and
placing a junction box lid on the junction box.
